(19) United States
(12) Patent Application Publication
(10) Pub. No.: US 2003/0213850 A1
(43) Pub. Date: Nov. 20, 2003

(54) Water faucet with automatic temperature adjustment according to the user's request

(76) Inventors: Yaron Mayer, Jerusalem (IL); Anat Cohen, Jerusalem (IL); Batya Bar-Hon, Jerusalem (IL); Haim Gadassi, Jerusalem (IL)

Correspondence Address: YARON MAYER, 21 Ahad Haam St., JERUSALEM, 92151, IL

(21) Appl. No.: 10/439,112

(22) Filed: May 12, 2003

(30) Foreign Application Priority Data
May 14, 2002 (IL) 149639

(51) Int. Cl. G05D 23/13; E03C 1/04

(52) U.S. Cl. 236/12.12; 4/676

(57) ABSTRACT

Water faucets that allow the user to manually mix hot and cold water until the desired temperature is felt have existed for a very long time. However, it typically can take up to a few minutes of various manual adjustments to get the desired temperature. Since the early 80's there existed also the possibility of doing the mixing automatically until a certain preselected temperature is reached, for example by an electric faucet with a temperature sensor. However, these patents did not solve the problem of the waiting time until the cold water in the hot water pipe gets out, and they did not solve the problem of reaching the desired heat if the hot water source is not hot enough and/or reaching the desired coldness of the cold water source is not cold enough. Clearly a more sophisticated system is needed. The present invention discloses an improved automated system that solves the above problems and creates an optimized combination, preferably in combination with at least one auxiliary temporary containment buffer and/or with an instant on-the-fly heater and/or a chilled water source.

### BACKGROUND OF THE INVENTION

1. Field of the Invention

The present invention relates to water faucets, and more specifically to a water faucet with automatic temperature adjustment according to the user's request, in way more efficient than what exists in the prior art, preferably in combination with an instant on-the-fly heater and/or at least one temporary storage buffer and/or a chilled water source. This can be considered a smart house gadget, and is useful also for saving water and/or electricity.

2. Background

Water faucets that allow the user to manually mix hot and cold water until the desired temperature is felt have existed for a very long time. However, it typically can take up to a few minutes of various manual adjustments to get the desired temperature (mainly due to the residue water in the hot water pipe, which gets cold since the previous use and due to pressure differences between the hold and cold sources), which causes both a waste of time and waste of water and inconvenience to the user. Another problem is that manually sensing the temperature is not sufficiently reliable and can be for example easily biased by accidental shifts during this playing back and forth with the manual adjustment, and over-shooting during this play back and forth can cause scalding by too hot water or unpleasant exposure to too cold water. So if for example 20 degrees Celsius is desired for washing a baby, it is unsafe to trust manual adjustment for reaching that, and mistakes or excess fluctuations can be dangerous. This is also especially inconvenient for example if only one hand is free for the manual adjustment.

Since the early 80's there existed also the possibility of doing the mixing automatically until a certain preselected temperature is reached, for example by an electric faucet with a temperature sensor, as described in U.S. Pat. No. 4,420,811 issued on Dec. 13, 1983 to Tarnay et. al. A number of additional patents on this subjects were issued in the following years, adding various features, such as for example: U.S. Pat. No. 4,854,498, of Aug. 8, 1989, U.S. Pat. No. 4,945,943 of Aug. 7, 1990, U.S. Pat. No. 5,032,992 of Jul. 16, 1991, U.S. Pat. No. 5,358,177 of Oct. 25, 1994, U.S. Pat. No. 5,577,660 of Nov. 26, 1996, U.S. Pat. No. 5,979,776 of Nov. 9, 1999, U.S. Pat. No. 6,250,558 of Jun. 26, 2001, and U.S. Pat. No. 6,318,638, of Nov. 20, 2001. Some patents, such as U.S. Pat. No. 5,511,723 of Apr. 30, 1996 & U.S. Pat. No. 5,806,761 of Sep. 15, 1998, describe control by a temperature sensitive shape-memory alloy instead of microprocessor control, however such a device is less flexible than a microprocessor and cannot take into account for example changes in water pressure that are also relevant for determining the correct mixing ratio. However all of these patents suffer from a major drawback: They do not solve the problem of the waiting time until the cold water in the hot water pipe gets out, and they do not solve the problem of reaching the desired heat if the hot water source is not hot enough and/or reaching the desired coldness if the cold water source is not cold enough. Clearly a more sophisticated system is needed.

On the other hand, there have been tank-less instant water heaters in use for at least 20 years, which can heat water on the fly and are typically activated automatically when the water starts flowing. Some of them are able to heat only cold water, which is wasteful since they cannot take advantage for example of water heated by solar tanks on the roof. Others use a thermostat and so can be used also with hotter water. In general such systems have the disadvantage that when working in full power they can cause a large strain on the power supply, requiring thousands of watts. On the other hand, they can be even 5 times more efficient than normal tank heaters since normal tanks heat more water than what is needed and not exactly at the same time, so much of the heat leaks out or is wasted, and also some of the heat is wasted during the transfer through the pipe for example if the hot water source is on the roof. However to the best of our knowledge these devices have never been used in the context or combination of automatic mixing of water sources. Also, typically such systems allow the user only the choice of a few levels of heating (for example a half-unit button and full unit button wherein the user can press either any one of them or both of them together), and not specifying and exact desired temperature. In addition, to the best of our knowledge there are no systems for mixing a normal cold water source with a chilled water source, manually or automatically, so that the user can only choose either a chilled or a normal water source, but not create a convenient mixture from such sources in a faucet.

### SUMMARY OF THE INVENTION

The present invention shows an improved automated system that solves the above problems and creates an optimized combination. One possible variation is that when the user waits for the residue cold water to come out of the hot water pipe the excess water is not wasted but is used for filling at least one temporary tank, which can be used later for example as water for the garden or for example for toilet flashing or even for example re-used in a loop instead or in addition to the cold water source, for example as soon as the water in the mixing chamber is hot enough and cold water is also needed. Another possible variation is to collect into at least one temporary tank, in addition or instead, also for example water that comes out of the sink after being used by the user, for example for use for toilet flushing, since toilet flushing is one of the largest sources of water wasting in homes. (In this case, preferably the temporary tank is above or at the same height as the toilet flush container, and/or an additional pump is used, and after the toilet is flushed, if the temporary tank not empty then preferably it is used for refilling the toilet flush container before any new water is allowed to refill it. Although such water, which might contain soup and various amounts of dirt is not good for example for gardening unless filtered, it is quite appropriate for toilet flushing. Another possible variation is to use for example one or more such temporary tank for more than one sink, and/or to use interconnections among these tanks, preferably with automatic load balancing between them). This feature can be used also independently of other features of this invention.

A more preferable variation is that the system contains also an instant tank-less water-heater (which can be for example connected to the hot water supply outlet before the hot water enters the mixing chamber, and/or within the mixing chamber itself, and/or downstream—after the water exists the mixing chamber), so that during the waiting time no time or water is wasted but instead the residue cold water from the hot water tank is instantly heated by the system until the hot water from the hot water source starts arriving. This has the further advantage that the instant heater can also keep boosting the heat if the hot water source is not hot enough for reaching the target temperature selected by the user. This is especially efficient when used for example in combination with a solar tank for example on the roof, since as long as the water from the solar tank is hot enough (which is usually what happens on non-cloudy days), the instant heater will have to work only for short bursts during the waiting period. The instant heater can be positioned for example above the sink, or hidden below the sink. On the other hand, if for example on a hot summer day, both the hot water source and the cold water source exceed the desired temperature, then the system preferably issues a warning to the user about this. Another possible variation is that the system contains also an instant cooling element that can for example lower the water temperature preferably on the fly, like an air conditioner or refrigerator, if needed. Another possible variation is that the system includes for example also a chilled water tank (or a connection to a 3^{rd} source—of chilled water) which constantly has cool water (or for example at least in the summer), and the user can also choose for example to use just the cold source (for drinking for example), or chose any desired temperature even below the temperature of the normal cold water source, and then the system can preferably use any combination of mixing the 3 water sources instead of only two. If a chilled water source is also used, preferably the user can also manually mix a normal cold water source with a chilled water source and/or also together with a hot water source, for example with any of the normal manual faucet controls for mixing 2 sources, except that for example one of the 2 sources is chilled water instead of hot water or for example there are 3 sources). If there are 3 sources (for example, chilled, normal, and hot), this can be done for example by turning 3 separate handles, or for example a single handle is used and for example rotating the handle to the left brings more hot water, the middle can use all 3 sources, and the right brings more chilled water, and moving the handle up and down increases or reduces the pressure. This can be useful also for example in mineral water bars where the user typically fills a glass by pressing a faucet connected to one or more containers.

The system might also include for example automatic pressure stabilization in any of the two (or more) water sources before entering the mixing chamber (for example making sure that the cold and hot water supplies always enter the input connections of the mixing chambers at approximately equal pressures) and/or upon exiting the mixing chamber (So that for example when the user opens or closes the manual flow control it does not effect the water flow directly mechanically but is translated by the system to some analog or digital value and is preferably regulated electronically by the system). Another possible variation is for example using a pump to increase the flow rate of one or more of the sources if it is low beyond a certain threshold instead of slowing down the faster one to the rate of the slow one, however this is preferably done only if the user opens the faucet at a flow rate sufficiently high to require this. However another possible variation is that the system only deals with reaching as close as possible to the desired temperature and the user manually adjusts the flow rate. Another possible variation is that the user manually adjusts the water flow as usual, but the system compensates for changes in the flow caused by itself: For example, if the pressure in the cold water supply is twice that of the hot water supply, when the system makes adjustments in the ratio between cold and hot water in order to keep the temperature constant, a side effect will be also a change in the output pressure at the user's end. In order to solve this, the system can for example control also an additional valve near the output of the mixing chamber that automatically compensates for the above changes, so that the water pressure that reaches the user's manual flow controller is always more or less the same. Preferably the system can also indicate to the user (for example on a preferably small, watertight LCD display) the current temperature of the water coming out of the mixing chamber and preferably also the current status of the system, for example the current ratio between cold and hot water, the amount of instant heat boosting conducted by the system, if any, and/or the current rate of water flow and/or total water consumption for example since opening the faucet, and/or a cumulative value of amount of water used over a longer time period, and/or for example the current temperature of the hot water source and/or of the cold water source (either near the faucet and/or for example on the roof, so that the user can have knowledge about the general state of the two basic sources, and/or also the temperature of the chilled source if a chilled water source is also used, etc.). The heat sensing is preferably done by a thermo-coupler or similar element which can respond preferably in a split-second, since a normal heat senor might not be fast enough. This heat sensing can be for example at the mixing chamber, or before it (upstream of it, for example only at the hot water pipe, or also an additional sensor at the cold water pipe), or after it (downstream of it), or any combination of the above. Another possible variation is that the system uses also for example pressure and/or flow rate sensors for the cold and the hot water supply respectively and takes this into account when calculating the adjustments needed. Preferably the system is controlled by a microprocessor. The heat adjustment is preferably done by a single electrical valve which can preferably adjust the ratio between the two (or more) water sources between the two extreme states of 0:100% and 100:0%, and any state in between. Another possible variation is to use for example a valve that slides between two (or more) extremes, moved for example by one or more toothed wheels. Another possible variation is using one electrical valve for the hot water and one for the cold, but that would be less efficient and more expensive. A further advantage of a single valve is that only a single rotation of 360 degrees or less can be sufficient to cover all the possible desired states. Also, a single electric valve that just changes the ratio between hot and cold water and lets the user manually determine the flow-rate of the water has the further advantage that for example in case of power outage the valve will never remain open allowing water to flow freely, unless the user manually allows this. Another possible variation is using battery back-up (for example normal or automatically recharged), so that when the power is out the battery is automatically activated. Anyway, also in other variations, preferably the system contains also a manual switch so that for example in case of electric power outage, the user can still have manual control. Another possible variation is that the system gets at least part of its energy for example from the water pressure itself, for example through a turbine, and/or from the heat of the hot water source. Another possible variation is that electrical power is transferred to at least some of the electronic parts (for example the CPU and/or the electrical valve) by induction, so that for example there is one or more electric coil outside the pipes (for example wrapped around the pipe, which can be especially convenient for example if it is a plastic pipe) which transfers energy for example to one or more internal coils coupled to the electronic units inside the pipes or inside the mixing chamber, etc. (This can solve isolation problems. Of course these coils can also act as a transformer for reducing the voltage at the same time). Another possible variation is to use similar methods (such as for example the temporary buffer and/or instant cooling) for taking care of hot water residue in the cold water pipe, for example on hot summer days.

On the other hand, in terms of user interface, a single constant temperature might not be desirable to most of the users, since for example for drinking water, most users might prefer cold water, whereas for taking a bath most user would prefer hotter water. Therefore, to give the user the familiar feeling of choice, one possible variation is that preferably the user has for example at least one manual valve for only cold water, one valve for normal hot water, and one valve for the automatically regulated temperature (for example with a separate rotateable selector coupled to it for setting the desired temperature), and the user can freely play with any combination of the above. Another possible variation is that preferably when the valve of the automatic system is opened, the other two are for example automatically closed or disabled. Another possible variation is that the user has for example 2 or more valves and can specify an assigned temperature for one or more of them, and then when that valve is opened preferably the others are disabled and the user just adjusts the flow rate up or down. Another possible variation is that, again, after specifying the temperature for each of the valves (or for example specifying it only for one of them—for example only the hot valve), the user can freely play with any of their combinations. So if for example there are only a cold and a hot valve and the user can specify the temperature only for the hot valve, this is similar to the normal experience of manually adjusting two valves, except that the hot one is automatically stabilized, so the setting is immediate and no waiting or readjusting back and forth is needed. Also, preferably this is in combination with a display of the actual temperature of the final resulting mixture, for example on an LCD display (in this case it means that an additional thermal sensor is needed at the user's manual mixing chamber, in addition to the senor in the automatic mixing chamber). A more preferable and simpler variation that gives the user an easier familiar feeling of control, is for example to use only a single valve, like the type used in manual singles valves, where for example a movement up opens or increases the water flow, a movement down decreases or closes the water flow, a movement right increases the cold water relative to the hot, and a movement left increases the hot water relative to the cold, except that instead of just feeling for the desired temperature and having to play back and forth as the cold residue from the hot pipe comes out and as the pressures change, there is also a scale that shows the desired temperature, and the automatic system tries its best to enable the desired temperature as soon as possible, and the user does not have to play back and forth. Another possible variation is similar to the above, except that there are for example two separate handles, one with a temperature indication that goes for example right and left, and another for just determining the flow rate that goes for example just up and down. Another possible variation is for example a central system which regulates the water temperature in more than one faucet together, and/or an instant heater which can be used for more than one faucet at the same time. Of course, various combinations of the above and additional variations are also possible.

### BRIEF DESCRIPTION OF THE DRAWINGS

FIG. 1 is a schematic illustration of a preferable configuration of the system, including the instant tank-less heater.

FIG. 2a is an illustration of a preferable variation where no instant heater is used and cold water during the waiting period is used to fill a temporary buffer.

FIGS. 3a-c show an example of a preferable design of a fast single electric valve for changing the ratio between hot and cold water.

FIGS. 4a-d show a few examples of preferable user controls.

FIG. 5 shows a configuration similar to FIG. 1, with the addition of an instant chiller.

FIGS. 6a-b show a configuration similar to FIG. 1, except that a chilled water container has been added to the system.

### IMPORTANT CLARIFICATION AND GLOSSARY

All these drawings are just scheme or exemplary drawings. They should not be interpreted as literal positioning, shapes, angles, or sizes of the various elements. Throughout the patent whenever variations or various solutions are mentioned, it is also possible to use various combinations of these variations or of elements in them, and when combinations are used, it is also possible to use at least some elements in them separately or in other combinations. These variations are preferably in different embodiments. In other words: certain features of the invention, which are described in the context of separate embodiments, may also be provided in combination in a single embodiment. Conversely, various features of the invention, which are described in the context of a single embodiment, may also be provided separately or in any suitable sub-combination. Throughout the patent, including the claims, whenever water faucet is mentioned, it can refer of course to any type of faucet, such as for example a bath tub faucet, a kitchen faucet, a shower faucet controller, etc. Also, although this invention has been described mainly in regard to water faucets, it can be used similarly also for example in industrial facilities where a certain temperature of water and/or other fluids and/or even gases is needed.

### DETAILED DESCRIPTION OF THE PREFERRED EMBODIMENTS

All of descriptions in this and other sections are intended to be illustrative examples and not limiting.

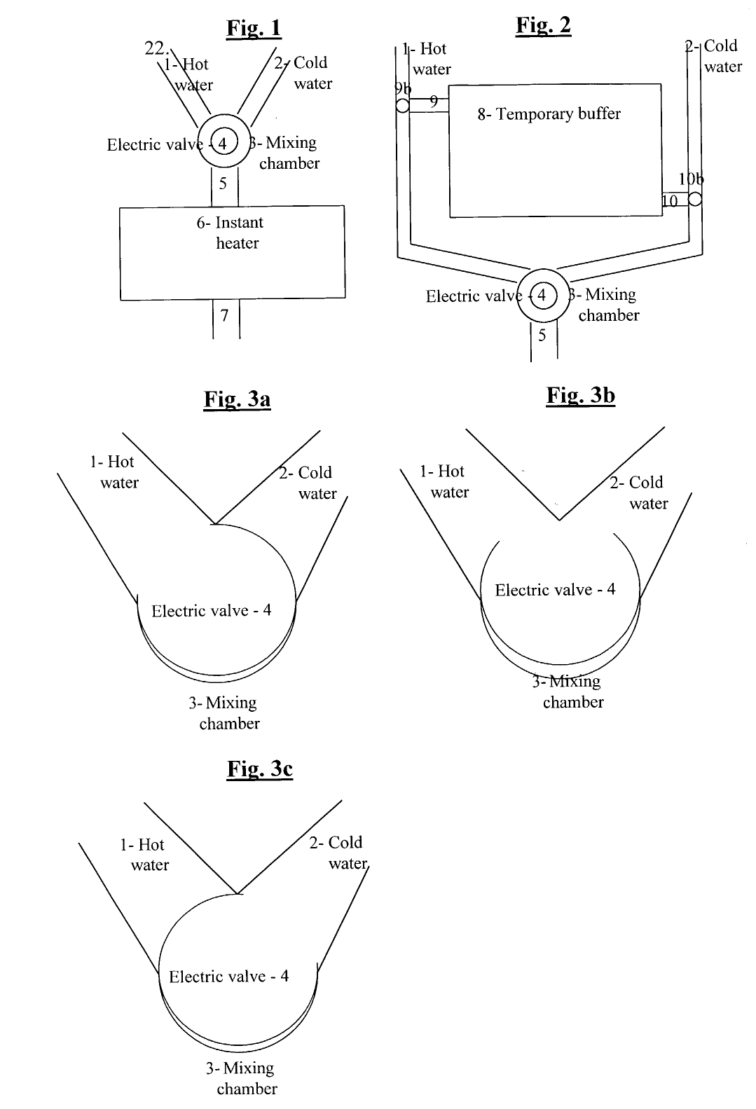

Referring to FIG. 1, we show an illustration of a preferable configuration of the system, including the instant tank-less heater (6). As can be seen, the cold water source (2) and hot water source (1) are mixed together in mixing chamber (3) with a preferably electric valve (4), and then connect through outlet (5) with the instant heater (6), and then come out through outlet 7. Preferably the instant heater is activated only at the waiting period until the residue cold water finishes coming out of the hot water pipe, or if the temperature of the hot water source is less than the user-selected target temperature. The instant heater (6) is preferably electric, but can be also for example based on gas or based on hit exchange with a radiator heating system. Of course, this is just an example, and the instant heater can also be for example instead on the hot water line just before the hot water enters the mixing chamber, or for example be an integral part of the mixing chamber itself, which can further save space.

Referring to FIG. 2, we show an illustration of a preferable variation where no instant heater is used and cold water during the waiting period is used to fill at least one temporary buffer (8) through connection 9, preferably with the aid of an electronic valve 9b. Next, when the hot water coming from the hot water source is hot enough and cold water is needed to mix with the hot water, the system preferably first uses the water from the temporary buffer (8) through connection 10 (or uses for example a combination of water from the buffer and water from the cold source, to mix with the hot water) preferably with the aid of electric valve 10b. If buffer 8 becomes full and the incoming water from the hot source is still not hot enough, then the system can for example temporarily let the extra cold water be wasted for a short time.

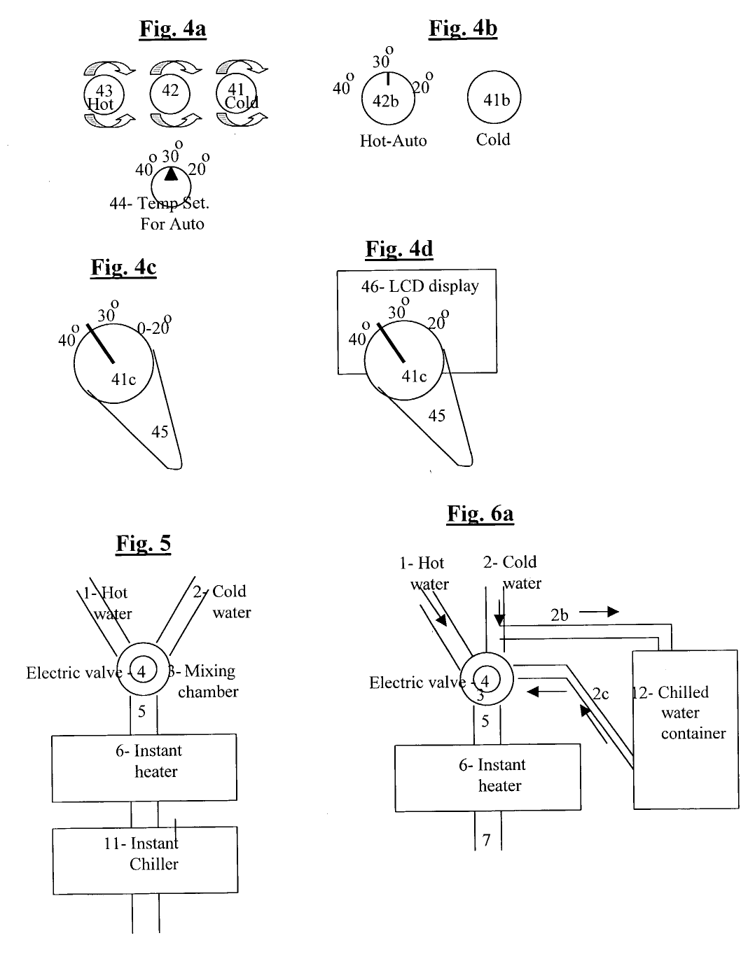

However, this option is less desirable, unless it is only for a very short time, since it means also that if the user does not want to use colder water during the waiting period, he/she has to wait with no water at all during the waiting period. However, preferably the waiting period becomes shorter, for example by letting the water flow into the temporary buffer at the fastest possible rate. Another possible variation is to use for example an additional pump for speeding up the process of dumping the residue cold water from the hot water pipe into the temporary buffer. Another possible variation is to use for example an additional switch which allows the user to decide each time if to use the water during the waiting period or not, so that for example for drinking water or washing his/her hands the user will typically want to use the water during the waiting period, but for example when preparing to take a shower the user might prefer to let the system take care of the water during the waiting period. (This is less of a problem if the user has also an option of using also normal valves, as explained below in the reference to FIGS. 4a-d, dealing with the user interface, since then the user has more choices available). Another possible variation is to add for example a stand-by mode, which means that the user can tell the system to start using the temporary buffer and let him/her know, for example by lighting a led or by some sound indicator, when the water is ready to use at the desired temperature, and then the user can actually start the water flowing at the desired temperature (this is useful for example when preparing a bath for a baby). Another possible variation is that during this standby mode preferably the system keeps checking the temperature of the water in the mixing chamber and/or in the hot water input pipe and automatically continues the process of removing residue cold water from the hot water pipe if needed. However this means that if the temporary buffer becomes full the system needs to start discarding water, which is more wasteful and therefore less desirable (This discarding can be either done for example visibly through the user's sink, or in the background, for example through a hidden part below the sink). Another possible variation is that during stand-by mode, whenever the user requests for example to use cold water from this or another faucet and/or for example flushes the toilet, the system automatically uses first water from the temporary buffer in addition to or instead of water from the cold water source (This means that in this case preferably the temporary water buffer can be used for more than one faucet at the same time, and/or that separate temporary buffers can be connected and the loads are preferably automatically balanced among them). However, if water in the temporary buffer is too hot for use as cold water, preferably the system uses it as is only for toilet flushing, and if used for cold water, preferably the system automatically checks the temperature of the water in the temporary buffer and automatically mixes it with water from the cold source at the proportions needed to keep the output cold enough (preferably through valve 10b). Another possible variation is that if the water from the temporary buffer or buffers can be shared among different faucets, it can also be used by other faucets for mixing with the water—if the water in the hot water pipe reaching that faucet is already hot enough and needs to be mixed with colder water. Another possible variation is that even while discarding cold residue water from the hot water pipe into the temporary buffer, the system always discards only part of it and lets the user use the other part, so the user never experiences a time without water during the waiting period, and, as explained above, preferably the waiting period also becomes shorter, for example by letting the water flow into the temporary buffer at a faster rate. Of course various combinations of the above and other variations can also be used.

Another possible variation is to use a combination of the versions of FIGS. 1 & 2, so that both the temporary buffer (8) and an instant heater (6) are used, and the buffer is used for example only to complement the operation of the instant heater for example for the first few seconds when it starts up. As explained in the summary, water from the temporary buffer can also be used, in addition or instead, for example for gardening or for flushing the toilet. Another possible variation, as described in the summary, is to use a similar but separate temporary buffer downstream, after the user has used the water from outlet 5 or 7, so that water coming out of the user's sink can be used later when needed, for example for flushing the toilet.

Referring to FIGS. 3a-c, we show an example of a preferable design of a fast single electric valve (4) in mixing chamber 3 for changing the ratio between hot water (1) and cold water (2). In the position shown in FIG. 3a the electric valve (4) is at the extreme allowing only water from the hot water source to flow in, in the position shown in FIG. 3b it allows a more or less equal proportions mixing, and in the position shown in FIG. 3c it is at the other extreme, allowing only water from the cold source to flow in. For fast response, one possible variation is that the electric valve is based on an AC motor, which has the advantage that unlike a DC motor, it can be started instantly and does not depend on the general load on the system. However, for converting speed to power, preferably one or more toothed wheels are used to transfer the momentum to the actual valve. Another possible variation is to use an AC motor but with a transformer and a low voltage, which adds additional safety to the system). Another possible variation is to use for example a transformer and a low voltage step motor (for example 12 Volts) in order to be able to quickly reach more precisely the exact desired position of the valve. Preferably the motor is controlled by a microprocessor or micro-controller. Another possible variation is to use for example a thermistor coupled to a resistor, so that it changes the voltage in response to temperature changes and to couple the motor also for example to a potentiometer, so that as the motor rotates it preferably rotates also the potentiometer until an equilibrium is reached with the voltage from the thermistor. However, like with the shape memory alloy, such an arrangement does not take into account differences in the pressure between the hot and cold water sources, so preferably if this arrangement is used, it is used in combination with an additional element or elements that for example change the voltage in response to changes in the incoming water pressure.

Preferably the electric valve has sufficient friction so that it moves only when given the instruction to move and not for example as the result of changing water pressure. Another possible variation is that there are for example small holes in the round circumference of the rotating part and for example one or more flexible hooks on the inner wall of the round chamber that surrounds the rotating part (and/or vice versa—holes in the inner circumference of the chamber and one or more flexible hooks on the rotating element), so that any position can be automatically locked when no additional force is exerted).

Referring to FIGS. 4a-d, we show a few examples of preferable user controls. FIG. 4a shows a preferable variation where the user has for example one preferably normal rotateable manual valve for only cold water (41), one manual preferably rotateable valve for normal hot water (43), and one manually preferably rotateable valve for the automatically regulated temperature (43), for example with a separate rotateable selector (44) coupled to it for setting the desired temperature, and preferably the user can freely play with any combination of the above. (In this version in case of a power outage the user can for example simply ignore the automatically temperature regulated valve and user the normal hot and cold valves until the power returns). Another possible variation is that preferably when the valve of the automatic system is opened, the other two are for example automatically closed or disabled. Another possible variation is that the user has for example 2 or more valves and can specify an assigned temperature for one or more of them, and then when that valve is opened preferably the others are disabled and the user just adjusts the flow rate up or down. Another possible variation is that, again, after specifying the temperature for each of the valves (or for example specifying it only for one of them—for example only the hot valve), the user can freely play with any of their combinations. (In case that the user can specify the regulated temperature for more than one valve, his can be accomplished for example by using more than one mixing chamber and/or more than one electric valve, or for example the system can sense the resulting combination and translate it to a single temperature and then still use preferably a single mixing chamber and a single mixing valve to deliver the request). So if for example there are only a cold valve (41) and an auto valve (42) and the user can specify the temperature only for the auto valve, this is similar to the normal experience of manually adjusting two valves, except that the hot one is automatically stabilized, so the setting is immediate or at least faster than in normal faucets and no waiting or readjusting is needed (or the waiting time is for example just a few seconds). Another possible variation is that preferably this is in combination with a display of the actual temperature of the final resulting mixture, for example on an LCD display (in this case it means that an additional thermal sensor is needed at the user's manual mixing chamber, in addition to the senor in the automatic mixing chamber). For simplicity, an example of only 3 degree choices is shown, but of course a much more detailed scale and/or a different temperature range can be used. Another possible variation, shown in FIG. 4b, is that for example rotating the auto-hot valve (42) changes the temperature setting and for example pressing it starts and increases water flow from it and depressing it decreases or stops the water flow (or vice versa), and similar pressing and depressing is used for controlling the cold water valve (41). A more preferable and simpler variation that gives the user an easier familiar feeling of control, is shown in FIG. 4c. The user has for example only a single valve (41) with convenient handle (45), like the type used in manual single valves, where for example a movement of the handle (45) up opens or increases the water flow, a movement of the handle down decreases or closes the water flow, a movement of the handle right increases the cold water relative to the hot, and a movement of the handle left increases the hot water relative to the cold, except that instead of just feeling for the desired temperature and having to play back and forth as the cold residue from the hot pipe comes out and as the pressures change, there is also a scale that shows the desired temperature, and the automatic system tries its best to enable the desired temperature as soon as possible, and the user does not have to play back and forth. However, in systems without a chilled water source and/or an instant chiller, preferably below a certain temperature the scale just shows a cold range (or for example just the word “cold”), since, unless the 3^{rd} chilled water source and/or the instant chiller is added, the system typically cannot ensure water at a temperature below the typical temperature of the cold water source, and on hot summer days the temperature of the cold water might be even higher. Another possible variation, shown in FIG. 4d, is that the desired temperature is displayed digitally for example on a preferably watertight LCD display (46) at the area where the user moves the handle (45) right or left, and if the system for example reads the temperature on the cold water source, it simply shows that temperature dynamically as the available minimum of the scale. However, that is less desirable, since it would mean that the user can't rely on the same temperature remaining if the position has not been changed. In case of an electrical outage, for example in the version shown in FIG. 4c, preferably the movements of the handle automatically start mechanically manually controlling directly also the hot and cold water ratio. This can be accomplished for example by a spring which is constantly pulled by the electric power, and when it is released for example a gear snaps into position and translates the movements of the handle to mechanically control the valve in the mixing chamber. Another possible variation is that the user pushes some lever in order to set this gear to enable manual control. Another possible variation is that there is for example an additional handle preferably coupled to the electric valve directly, which the user can use separately for manually controlling its positions if the power is down. Of course various combinations of the above and other variations are also possible.

Referring to FIG. 5, we show a configuration similar to FIG. 1, with the addition of an instant chiller (11), for example after the heater, however it can be also for example combined with the heater in one small container (or for example together within the mixing chamber), or before the heater, or for example next to it side-by-side, for example with the heater connected to the hot water source before it enters the mixing chamber and the instant chiller connected to the cold water source before it enters the mixing chamber.

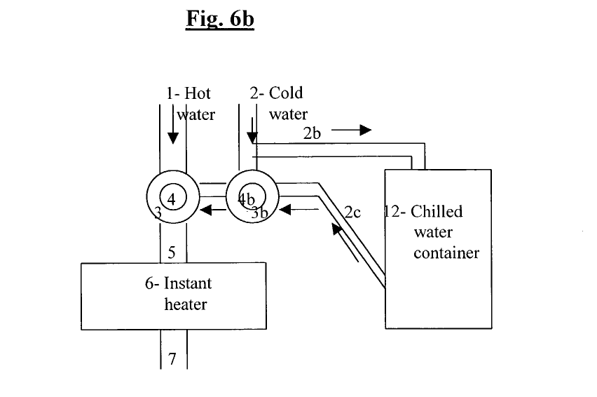

Referring to FIGS. 6a-b, we show a configuration similar to FIG. 1, except that a chilled water container (12) has been added to the system, so preferably the mixing chamber (3) is able to mix any ratio between the 3 sources (as shown in FIG. 6a), or for example a 2^{nd} mixing chamber (3b) is added to mix for example between the cold and chilled source before they enter together into chamber 3 (shown in FIG. 6b). Preferably water input for the chilled container (12) comes also from the cold water source (2), through connection 2b and goes back to the mixing chamber through connection 2c. The version shown in FIG. 6a is more preferable since only one electric valve (4) is needed.

While the invention has been described with respect to a limited number of embodiments, it will be appreciated that many variations, modifications, expansions and other applications of the invention may be made which are included within the scope of the present invention, as would be obvious to those skilled in the art.

We claim:

1. A system for automatically controlling the temperature of water outflow in faucets according to a user-selected target temperature, comprising:
a. A cold water supply.
b. A hot water supply.
c. A mixing chamber.
d. At least one fast temperature sensor.
e. At least one automatically controlled valve.
f. At least one of: 1. At least one instant heating element, capable of heating water on the fly, 2. At least one temporary water buffer for holding residue cold water from the hot-water pipe, and 3. At least one temporary water buffer for holding residue hot water from the cold-water pipe.

2. The system of claim 1 wherein at least one of the following features exits:
a. The system is controlled by microprocessor and the at least one automatically controlled valve is controlled electronically.
b. The system gets at least part of its energy from the water pressure itself and/or from the heat of the hot water source.
c. Power is transferred to at least one of the electrical parts through induction from at least one coil that is located outside of the pipes.
d. When the user waits for residue cold water to come out of the hot water pipe, at least some of the excess water is held in at least one temporary tank.
e. When the user waits for residue hot water to come out of the cold water pipe, at least some of the excess water is held in at least one temporary tank.
f. An Instant water-heater is connected to the hot water supply outlet at least one of: Before the water enters the mixing chamber, within the mixing chamber itself, and Downstream—after the water exists the mixing chamber.
g. An instant water heater can also keep boosting the heat if the hot water source is not hot enough for reaching the target temperature selected by the user.
h. The hot water supply is warmed by a solar tank.
i. The system contains also an instant cooling element that can lower the water temperature on the fly when needed.
j. The system includes also at least one of a chilled water tank or a connection to a 3^{rd} source—of chilled water which constantly has cool water.
k. The instant heater is based on at least one of: Electricity, Gas, and Heat exchange with the radiator heating system.
l. The system uses also at least one of pressure and flow rate sensors for the cold and the hot water supply respectively and take this into account when calculating the adjustments needed.

3. The system of claim 2 wherein one of the following features exists:
a. Water from the temporary tank can be used later for at least one of: water for the garden or toilet flashing.
b. Water from the temporary tank coupled to the hot water source is re-used when the water in the mixing chamber is hot enough and cold water is also needed.
c. Water from a temporary tank coupled to the cold water source is re-used when the water in the mixing chamber is cold enough and hot water is also needed.
d. If both the hot water source and the cold water source exceed the desired temperature, the system issues a warning to the user about this.
e. The user can also choose to use just the cold source, or chose any desired temperature even below the temperature of the normal cold water source.
f. The system can use any combination of mixing the 3 water sources instead of only two.
g. The 3 sources are mixed at the same mixing chamber.
h. The cold and chilled water are mixed at a separate mixing chamber.

4. The system of claim 1 wherein automatic pressure stabilization is also used.

5. The system of claim 4 wherein at least one of the following exists regarding said pressure stabilization:
a. Said stabilization is used in at least one of the two water sources before entering the mixing chamber.
b. Said stabilization more or less equalizes the water pressures of the water sources upon entering the mixing chamber.
c. Said stabilization is done upon exiting the mixing chamber.
d. The user manually adjusts the water flow as usual, but the system compensates for changes in the flow caused by its own changing of the ratio between the cold and warm water.
e. The system compensates for changes in the flow by controlling also an additional valve near the output of the mixing chamber that automatically compensates for the above changes.

6. The system of claim 1 wherein the system can also indicate to the user the at least one of: The current temperature of the water coming out of the mixing chamber, the current ratio between cold and hot water, the amount of instant heat boosting conducted by the system, if any, the current rate of water flow, the total water consumption since opening the faucet, the cumulative amount of water used over a longer time period, the current temperature of at least one of the hot water and cold water sources near the faucet, and the current temperature of at least one of the hot water and cold water sources on the roof.

7. The system of claim 1 wherein the heat sensing is done by at least one of the following:
a. A thermo-coupler.
b. The system uses a heat sensor at the mixing chamber itself.
c. The system uses a heat sensor before the mixing in at least one of the hot water pipe and the cold water pipe.
d. The system uses a heat sensor after the mixing chamber.

8. The system of claim 1 wherein user control is enabled by at least one of the following:
a. The system contains also a manual switch so that in case of electric power outage, the user can still have manual control.
b. The user has at least one manual valve for cold water, one manual valve for normal hot water, and one valve for the automatically regulated hot water, and the user can freely play with any combination of the above.
c. The user has at least one manual valve for cold water, one manual valve for normal hot water, and one valve for the automatically regulated hot water, and when the valve of the automatic system is opened, the other two are automatically closed.
d. The user has at least two valves and can specify an assigned temperature in at least one of them, and then when that valve is opened the other valves are disabled and the user just adjusts the flow rate up and down.
e. After specifying the temperature for at least one of the valves, the user can freely play with any of their combinations.
f. The user can use a single valve, like the type used in manual singles valves, except that instead of just feeling for the desired temperature and having to play back and forth as the cold residue from the hot pipe comes out and as the pressures change, there is also a scale that shows the desired temperature, and the automatic system tries its best to enable the desired temperature as soon as possible.
g. There are two separate handles, one with a temperature indication, and another for just determining the flow rate.
h. Rotating the control valve of the temperature-regulated water changes the temperature setting and pressing and depressing it changes the water flow.
i. An additional switch allows the user to decide each time if to use the water from the automatically regulated source during the waiting period or not.
j. The user can tell the system to use the temporary buffer and let him/her know when the water is ready to use at the desired temperature, and then the user can actually start the water flowing at the desired temperature.

9. The system of claim 2 wherein at least one of the following features exists:
a. Both a temporary buffer and an instant heater are used, and the temporary buffer is used only to complement the operation of the instant heater for the first few seconds when it starts up.
b. The waiting period becomes shorter by letting the water flow into the temporary buffer at the fastest possible rate.
c. An additional pump is used for speeding up the process of dumping the residue cold water from the hot water pipe.
d. During standby—until the user actually starts using the water—the system keeps checking the temperature of the water in at least one of the mixing chamber and the hot water input pipe, and automatically continues the process of removing residue cold water from the hot water pipe if needed.
e. While discarding cold residue water from the hot water pipe into a temporary buffer, the system always discards only part of it and lets the user use the other part, so the user never experiences a time without water during the waiting period.
f. When the user waits for residue hot water to come out of the cold water pipe, at least some of the excess water is held in at least one temporary tank.
g. When the user waits for residue hot water to come out of the cold water pipe, at least some of the excess water is held in at least one temporary tank, and water from this temporary tank is re-used when the water in the mixing chamber is cold enough and hot water is also needed.
h. A pump can be used to increase the flow rate of one of the sources if it is low beyond a certain threshold instead of slowing down the faster one to the rate of the slow one.

10. The system of claim 1 wherein at least one of the following features exist:
a. A central system can regulate the water temperature in more than one faucet together.
b. An instant heater can be used for more than one faucet at the same time.
c. A temporary water buffer can be used for more than one faucet at the same time.
d. Separate temporary buffers can be connected.
e. Water that comes out of the sinks after being used by the user is collected into at least one dirty-water temporary tank for use for toilet flushing.

11. A method for automatically controlling the temperature of water outflow in faucets according to a user-selected target temperature, comprising:
a. Connecting a cold water supply and a hot water supply into A mixing chamber.
b. Using at least one fast temperature sensor.
c. Using at least one automatically controlled valve.
d. Using at least one of: 1. At least one instant heating element, capable of heating water on the fly, 2. At least one temporary water buffer for holding residue cold water from the hot-water pipe, and 3. At least one temporary water buffer for holding residue hot water from the cold-water pipe.

12. The method of claim 11 wherein at least one of the following features exits:
a. The system is controlled by microprocessor and the at least one automatically controlled valve is controlled electronically.
b. The system gets at least part of its energy from the water pressure itself and/or from the heat of the hot water source.
c. Power is transferred to at least one of the electrical parts through induction from at least one coil that is located outside of the pipes.
d. When the user waits for residue cold water to come out of the hot water pipe, at least some of the excess water is held in at least one temporary tank.
e. When the user waits for residue hot water to come out of the cold water pipe, at least some of the excess water is held in at least one temporary tank.
f. An Instant water-heater is connected to the hot water supply outlet at least one of: Before the water enters the mixing chamber, within the mixing chamber itself, and Downstream—after the water exists the mixing chamber.
g. An instant water heater can also keep boosting the heat if the hot water source is not hot enough for reaching the target temperature selected by the user.
h. The hot water supply is warmed by a solar tank.
i. The system contains also an instant cooling element that can lower the water temperature on the fly when needed.
j. The system includes also at least one of a chilled water tank or a connection to a 3^{rd} source—of chilled water which constantly has cool water.
k. The instant heater is based on at least one of: Electricity, Gas, and Heat exchange with the radiator heating system.
l. The system uses also at least one of pressure and flow rate sensors for the cold and the hot water supply respectively and take this into account when calculating the adjustments needed.

13. The method of claim 12 wherein one of the following features exists:
a. Water from the temporary tank can be used later for at least one of: water for the garden or toilet flashing.
b. Water from the temporary tank is re-used when the water in the mixing chamber is hot enough and cold water is also needed.
c. Water from a temporary tank coupled to the cold water source is re-used when the water in the mixing chamber is cold enough and hot water is also needed.
d. If both the hot water source and the cold water source exceed the desired temperature, the system issues a warning to the user about this.
e. The user can also choose to use just the cold source, or chose any desired temperature even below the temperature of the normal cold water source.
f. The system can use any combination of mixing the 3 water sources instead of only two.
g. The 3 sources are mixed at the same mixing chamber.
h. The cold and chilled water are mixed at a separate mixing chamber.

14. The method of claim 11 wherein automatic pressure stabilization is also used.

15. The method of claim 14 wherein at least one of the following exists regarding said pressure stabilization:
a. Said stabilization is used in at least one of the two water sources before entering the mixing chamber.
b. Said stabilization more or less equalizes the water pressures of the water sources upon entering the mixing chamber.
c. Said stabilization is done upon exiting the mixing chamber.
d. The user manually adjusts the water flow as usual, but the system compensates for changes in the flow caused by its own changing of the ratio between the cold and warm water.
e. The system compensates for changes in the flow by controlling also an additional valve near the output of the mixing chamber that automatically compensates for the above changes.

16. The method of claim 11 wherein the system can also indicate to the user the at least one of: The current temperature of the water coming out of the mixing chamber, the current ratio between cold and hot water, the amount of instant heat boosting conducted by the system, if any, the current rate of water flow, the total water consumption since opening the faucet, the cumulative amount of water used over a longer time period, the current temperature of at least one of the hot water and cold water sources near the faucet, and the current temperature of at least one of the hot water and cold water sources on the roof.

17. The method of claim 11 wherein the heat sensing is done by at least one of the following:
a. A thermo-coupler.
b. The system uses a heat sensor at the mixing chamber itself.
c. The system uses a heat sensor before the mixing in at least one of the hot water pipe and the cold water pipe.
d. The system uses a heat sensor after the mixing chamber.

18. The method of claim 11 wherein user control is enabled by at least one of the following:
a. The system contains also a manual switch so that in case of electric power outage, the user can still have manual control.
b. The user has at least one manual valve for cold water, one manual valve for normal hot water, and one valve for the automatically regulated hot water, and the user can freely play with any combination of the above.
c. The user has at least one manual valve for cold water, one manual valve for normal hot water, and one valve for the automatically regulated hot water, and when the valve of the automatic system is opened, the other two are automatically closed.
d. The user has at least two valves and can specify an assigned temperature in at least one of them, and then when that valve is opened the other valves are disabled and the user just adjusts the flow rate up and down.
e. After specifying the temperature for at least one of the valves, the user can freely play with any of their combinations.
f. The user can use a single valve, like the type used in manual singles valves, except that instead of just feeling for the desired temperature and having to play back and forth as the cold residue from the hot pipe comes out and as the pressures change, there is also a scale that shows the desired temperature, and the automatic system tries its best to enable the desired temperature as soon as possible.
g. There are two separate handles, one with a temperature indication, and another for just determining the flow rate.
h. Rotating the control valve of the temperature-regulated water changes the temperature setting and pressing and depressing it changes the water flow.
i. An additional switch allows the user to decide each time if to use the water from the automatically regulated source during the waiting period or not.
j. The user can tell the system to use the temporary buffer and let him/her know when the water is ready to use at the desired temperature, and then the user can actually start the water flowing at the desired temperature.

19. The method of claim 12 wherein at least one of the following features exists:
a. Both a temporary buffer and an instant heater are used, and the temporary buffer is used only to complement the operation of the instant heater for the first few seconds when it starts up.
b. The waiting period becomes shorter by letting the water flow into the temporary buffer at the fastest possible rate.
c. An additional pump is used for speeding up the process of dumping the residue cold water from the hot water pipe.
d. During standby—until the user actually starts using the water—the system keeps checking the temperature of the water in at least one of the mixing chamber and the hot water input pipe, and automatically continues the process of removing residue cold water from the hot water pipe if needed.
e. While discarding cold residue water from the hot water pipe into a temporary buffer, the system always discards only part of it and lets the user use the other part, so the user never experiences a time without water during the waiting period.
f. When the user waits for residue hot water to come out of the cold water pipe, at least some of the excess water is held in at least one temporary tank.
g. When the user waits for residue hot water to come out of the cold water pipe, at least some of the excess water is held in at least one temporary tank, and water from this temporary tank is re-used when the water in the mixing chamber is cold enough and hot water is also needed.
h. A pump can be used to increase the flow rate of one of the sources if it is low beyond a certain threshold instead of slowing down the faster one to the rate of the slow one.

20. The method of claim 11 wherein at least one of the following features exist:
a. A central system can regulate the water temperature in more than one faucet together.
b. An instant heater can be used for more than one faucet at the same time.
c. A temporary water buffer can be used for more than one faucet at the same time.
d. Separate temporary buffers can be connected.
e. Water that comes out of the sinks after being used by the user is collected into at least one dirty-water temporary tank for use for toilet flushing.

21. A water faucet wherein the user can at least one of manually and automatically adjust the mixture between at least one of:
a. A cold water source and a chilled water source.
b. A hot water source, a cold water source, and a chilled water source.
